(19) United States
(12) Patent Application Publication
(10) Pub. No.: US 2024/0286084 A1
(43) Pub. Date: Aug. 29, 2024

(54) FLOW REVERSAL OF INTERNAL CIRCULATION MEMBRANE SEPARATION SYSTEMS

(71) Applicant: Nadav Efraty, Newton, MA (US)

(72) Inventor: Nadav Efraty, Newton, MA (US)

(21) Appl. No.: 18/438,441

(22) Filed: Feb. 10, 2024

Related U.S. Application Data
(60) Provisional application No. 63/486,720, filed on Feb. 24, 2023.

(51) Int. Cl. B01D 65/08

(52) U.S. Cl. CPC B01D 65/08; B01D 2321/2083

(57) ABSTRACT

The present invention provides a membrane separation process comprising a pressurized feed of solution that is combined with a repressurized, internal circulation of a concentrated solution. This combined flow of feed solution and concentrated solution may be introduced to either end of pressurized vessels containing membranes and this direction of flow is periodically reversed. This combination of repressurized internal circulation and reversal of the direction of flow allows for manipulations of concentration gradients both along the length of membranes in the pressure vessel and concentration gradients within the boundary layers at the surface of the membranes

### FIELD OF INVENTION

This invention relates to a membrane separation process.

### BACKGROUND TO THE INVENTION

Membrane processes are commonly used for either purifying or concentrating solutions. This is accomplished by semi-permeable membrane materials allowing some components within the solution to permeate through the membrane at different rates and some components not at all. This application of membranes allows for solutions to have some components concentrated on one side of the membrane and rarified on the other, thus allowing for the development of selective separation processes.

For example, in the field of water and wastewater treatment membrane processes are used to purify a water solution of unwanted contaminants before that water is put to beneficial use in the case of water or before it is disposed of into the environment in the case of wastewater. In these applications, the membrane processes are separating the solution into two streams. One stream is the purified water wherein the contaminant concentration has been reduced. The other stream is the unwanted portion where the concentration of the contaminants has been increased.

In other cases, such as juice and milk processing, the objective is to concentrate the components in the solution. In these applications, the stream that is concentrated is put to beneficial use while the purified solution stream is the unwanted component. However, in both of the examples rendered it is typically desired to minimize the volume of the concentrated stream.

Many challenges in operating these membrane separation systems involve fouling of the membranes with insoluble material or scaling with sparingly soluble materials. These issues are amplified in systems wherein the concentrated stream is minimized in volume. A plethora of methods have been described for reducing the effects of fouling and scaling on membrane systems. One of these is described in U.S. Pat. No. 9,649,598 (to Gilron), which suggests that periodically reversing the direction of flow across the membrane allows the precipitation of sparingly soluble salts may be minimized if these reversals take place on a time scale shorter than the “induction time”. The induction time being defined as the required time for a supersaturated aqueous solution to start precipitating sparingly soluble salts. Since in these membrane separation systems, the concentration of the sparingly soluble salts increases as it passes through the system the precipitation will occur first near the exit from the pressure vessel. Therefore, by switching the direction before that precipitation can occur this concern is minimized.

Another method of minimizing the effects of fouling and scaling on membrane systems is described in U.S. Pat. No. 8,025,804 (to Avi Efraty), which defines a continuous closed-circuit membrane separation process. This closed-circuit process directs the concentrated fraction of the solution back to blend with a continuous feed of the raw solution. This internal circulation of the concentrated solution requires a repressurization of flow in order to blend it in with the pressurized feed flow, which allows for independent control of the velocity of the crossflow on the membranes versus the flow of the purified solution through the membranes. This independent control of the crossflow allows for managing of concentration polarization in the boundary layer at the surface of the membrane. This concentration polarization can cause a much higher concentration of sparingly soluble salts at the surface of the membrane when compared to the nearby bulk solution. Minimizing this effect prevents scaling that would otherwise not occur due to concentrations in the bulk solution. This closed circuit system also periodically opens to purge the concentrated solution from the system. The purging may also minimize the scaling of sparingly soluble salts if it is done prior to the induction time.

### SUMMARY OF THE INVENTION

The present invention provides a membrane separation process. In this separation process, membranes within a pressurized vessel are used to separate a feed solution into two separate solution streams: one with higher concentration of soluble and/or insoluble components and one with a lower concentration of soluble and/or insoluble components. The invention is comprised of a pressurized feed solution that is combined with a repressurized, internal circulation of all of or a percentage of the more concentrated solution resulting from the separation process. This combined flow of feed solution and concentrated solution may be introduced to either end of pressurized vessels containing membranes and this direction of flow is periodically reversed.

The present invention, through internal recirculation and periodic reversal of combine feed and concentrated solution, allows for control of velocity and direction of cross flow along the membranes independent of the exiting flow of both the purified and concentrated solution. This independent control allows for manipulation of the concentration gradients of soluble and/or insoluble components along the length of the membranes within the pressure vessel and the behavior of the boundary layer near the surface of the membranes. These manipulations may be used to minimize the unwanted effects of fouling and scaling on the membrane surface.

The present invention provides advantages over previous inventions as it uniquely allows for the control of both the velocity and direction of crossflow independent from control of the purified and concentrated stream flow rates.

### BRIEF DESCRIPTION OF THE DRAWINGS

In the drawings:

FIG. 1 is a schematic process flow diagram for a particular, non-limiting embodiment of a membrane separation system that illustrates the scheme of the invention.

FIG. 2 is a schematic process flow diagram that is prior art showing an invention where the direction of flow across the membrane surface may be changed.

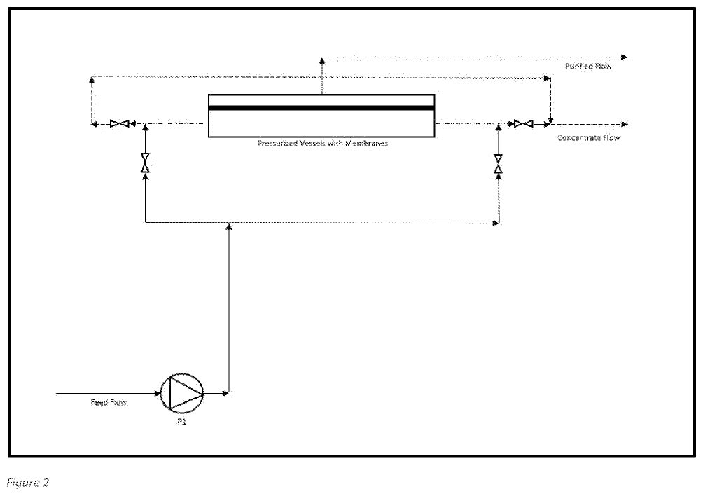

FIG. 3 is a schematic process flow diagram that is prior art showing an invention where velocity of the flow across the membrane surface may be controlled independently from the feed flow.

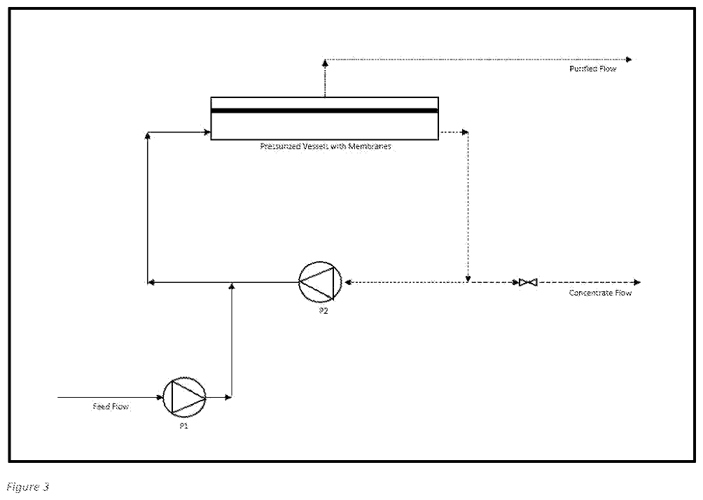

### DETAILED DESCRIPTION OF AN EMBODIMENT OF THE INVENTION

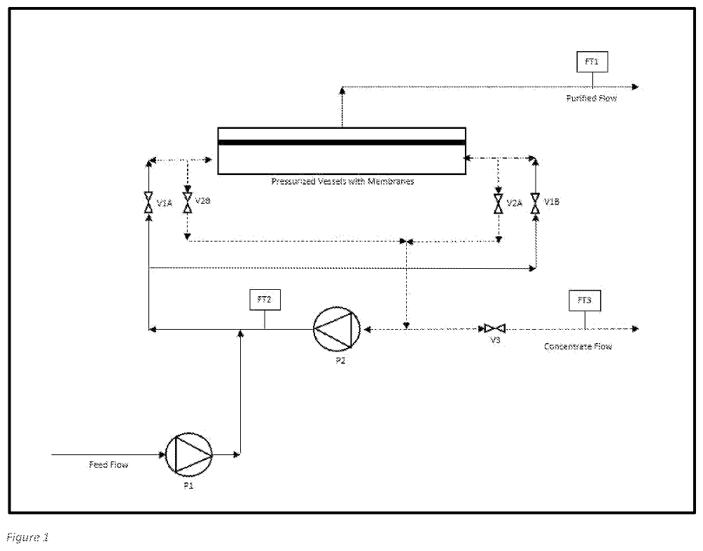

Referring now to FIG. 1, there is shown a membrane separation system that is a particular, non-limiting embodiment of the invention.

There is a feed flow of solution (Qf) that enters a pump (P1). P1 is controlled by a flow measuring device on the permeate flow (FT1) or on the feed flow or by a conductivity measuring device (on the permeate) or by a timer or by other means to maintain specific flow rate of purified solution (Qp) for a specific period of time. Qf is blended with the circulation flow (Qr) after it discharges from a pump (P2). P2 could be controlled by a flow measuring device (FT2) or work at constant conditions to maintain a specific flow rate across the membranes for a specific period of time.

A set of control valves (V1A, V2A, V1B, V2B) on the suction side of P2 and on the combined discharge flow (Qf+Qr) of P1 and P2 will control the direction of flow across the membranes. When V1A and V2A are open, then V1B and V2B are closed and the flow across the membranes will be from left to right. Conversely, when V1A and V2A are closed, then V1B and V2B are open and the flow across the membranes will be from right to left. The initiation of the switch from left-to-right to right-to-left may be done by a timer, a flow counter on FT1, a conductivity measurement in the closed loop or any other signal.

A Control valve on the concentrate flow line (V3) will be opened or closed to control the concentrate flow (Qc) for a specific period of time as measured by a flow measuring device (FT3). V3 will have three modes of operation: closed circuit (V3 closed), plug flow (V3 open), and partial recirculation (V3 partially open). The partial recirculation mode may either operate continuously or it may operate periodically as part of the purge process of a closed circuit system. The signal to switch to any given mode of operation will be provided by a timer, a flow counter on FT1, a flow counter on FT3, conductivity or any other signal. When V3 is in a partially open state, the amount of opening will be controlled by FT3 or by a conductivity meter to maintain a specific Qc. It is noted that V3 could be replaced by multiple concentrate discharge valves in order to reduce the length of the high-pressure piping in the system.

In this novel arrangement both the velocity and direction of the flow Qr may be independently controlled from the purified and concentrated flows, Qp and Qc. Simultaneously, the Qc may be discharged in a continuous rate or in a semi-batch mode. All while the Qp rate is also independently controlled. All of these control parameters may be optimized to maintain an operation that minimizes scaling of sparingly soluble salts on the membrane and particulate fouling on the membrane surfaces while simultaneously minimizing the overall volume of Qc.

1. A method for separating a feed solution into a volume with higher concentration of soluble and/or insoluble material and a volume of lower concentration of soluble and/or insoluble material, the method comprising of:
a. Pressurized feed of a solution;
b. circulation system for repressurizing from 0% to 100% of a separated higher concentration solution and combining it with the pressurized feed solution;
c. control system for directing the combined flow to either end of a pressurized vessel that contains membrane modules used to split a solution into two streams: one with a higher concentration of a soluble and/or insoluble material and one with a lower concentration of a soluble and/or insoluble material;

2. A method of claim 1 wherein a control system for altering the percentage of recycling from 0% to 100% of a separated higher concentration solution to a pressurized feed of solution is alternated between 100% for a closed-circuit operation and a value lower than 100% (could be 0%) for a plug flow operation.

3. A method of claim 1 wherein a control system for altering the percentage of recycling from 0% to 100% of a separated higher concentration solution to a pressurized feed of solution is between higher than 0% and lower than 100% thus providing a continuous partial recirculation.

4. A method of claim 1 wherein recycling system for directing from 0% to 100% of a separated higher concentration solution to a pressurized feed of solution is controlled in a manner to increase turbulent mixing at a membrane surface from both ends of the membranes;

5. A method of claim 1 wherein a control system for altering direction for which end of a pressurized vessel a combined stream of pressurized feed solution and recycled, separated higher concentration solution is fed is triggered to prevent sparingly soluble salts from scaling on a membrane or particulate fouling on a membrane surface and/or entrance to a membrane module;

6. A method of claim 1 wherein a control system for altering direction for which end of a pressurized vessel a combined stream of pressurized feed solution and recycled, separated higher concentration solution and a control system for altering the percentage of recycling from 0% to 100% of a separated higher concentration solution to a pressurized feed of solution is alternated between 100% for a closed-circuit operation and 0% for a plug flow operation with a switch to plug flow are triggered in coordination to prevent sparingly soluble salts from scaling on a membrane;

7. A method of claim 1 wherein a control system for altering direction for which end of a pressurized vessel a combined stream of pressurized feed solution and recycled, separated higher concentration solution is fed is triggered to prevent particulate fouling on a membrane surface and/or entrance to a membrane module.

8. A method of claim 1 wherein a control system for altering direction for which end of a pressurized vessel a combined stream of pressurized feed solution and recycled, separated higher concentration solution and a control system for altering the percentage of recycling from 0% to 100% of a separated higher concentration solution to a pressurized feed of solution is alternated between 100% for a closed-circuit operation and 0% for a plug flow operation with a switch to plug flow are triggered in coordination to minimize the growth of unwanted biological growth on a membrane and/or within a pressure vessel.
